(19) United States
(12) Patent Application Publication
(10) Pub. No.: US 2011/0234765 A1
(43) Pub. Date: Sep. 29, 2011

(54) IMAGE PROCESSING APPARATUS, IMAGE PROCESSING METHOD, IMAGE PROCESSING PROGRAM, AND COMPOUND EYE DIGITAL CAMERA

(75) Inventor: Koichi TANAKA, Saitama-shi (JP)

(73) Assignee: FUJIFILM CORPORATION, Tokyo (JP)

(21) Appl. No.: 13/040,944

(22) Filed: Mar. 4, 2011

(30) Foreign Application Priority Data
Mar. 24, 2010 (JP) 2010-068122

(51) Int. Cl. H04N 13/02; H04N 5/228; G06K 9/00

(52) U.S. Cl. 348/47; 348/222.1; 382/162; 348/E05.031; 348/E13.074

(57) ABSTRACT

A parallax map is generated by corresponding left and right images with each other through stereo matching based on the left image. An attention pixel is set on the parallax map, and a window of a predetermined size centering on a pixel (left image attention pixel) on the left image corresponding to the attention pixel is set in the left image. Pixels having an RGB value similar to the RGB value of the left image attention pixel from among the pixels in the window are extracted, and the parallax of a pixel on the parallax map corresponding to each extracted pixel is entered into a parallax histogram to generate a parallax histogram. When the frequency of the attention pixel is smaller than a predetermined value, the parallax of the attention pixel is corrected with a parallax having the maximum frequency value of the parallax histogram.

### BACKGROUND OF THE INVENTION

1. Field of the Invention

The present invention relates to an image processing apparatus, an image processing method, an image processing program, and a multi-eye digital camera. In particular, the present invention relates to an image processing apparatus, an image processing method, an image processing program, and a multi-eye digital camera which generate and correct a parallax map for generating an image for stereoscopic view.

2. Description of the Related Art

In the related art, stereo matching is carried out between images captured from two or more different viewpoints to obtain parallax information between corresponding pixels, and the distance of each point on a target object is calculated or the shape of the target object is measured.

For example, a stereo image processing apparatus is proposed in which a stereo processing unit creates distance information for each small region on the basis of a stereo image pair captured by a stereo camera (JP1999-248446A (JP-H11-248446A)). In the stereo image processing apparatus described in JP1999-248446A (JP-H11-248446A), a 3×3 small region group around a small region for attention is extracted from the created distance information by a majority filter. A histogram is created with a frequency added in accordance with the address and parallax of each small region. The maximum frequency parallax of the histogram is compared with the parallax of the small region for attention. When the comparison result satisfies the condition set in advance, the parallax of the small region for attention is corrected with the maximum frequency parallax.

An image processing apparatus is also proposed in which a distance relationship information image is generated by corresponding first and second images with each other through area-based matching and, from among the pixels of the distance relationship information image, pixels having certainty regarding a real corresponding point equal to or smaller than a predetermined value are selected as a correction-target pixel which will be subjected to distance relationship information correction (see JP2000-121319A). In the image processing apparatus described in JP2000-121319A, a predetermined region including the correction-target pixel is set as a search block, pixels which satisfy a predetermined condition regarding certainty are selected from among a plurality of pixels within the search block, and the distance relationship information of the correction-target pixel is corrected by using the distance relationship information of the selected pixels.

### SUMMARY OF THE INVENTION

According to the technique described in JP1999-248446A (JP H11-248446A), the parallax of the small region for attention is corrected with the maximum frequency parallax of the histogram. However, in the case of a scene in which a foreground and a background are mixed, there is a problem in that, when a small region in the vicinity of the boundary between the foreground and the background is featured, the parallax of the region may be corrected with the parallax of the background portion regardless of the region belonging to the foreground portion.

According to the technique described in JP2000-121319A, in order to correct the distance relationship information of the correction-target pixel, a pixel (most easily evaluated pixel) having the minimum evaluation value of area-based matching is selected as a pixel having certainty satisfying a predetermined condition. In this case, however, a pixel having the minimum evaluation value of area-based matching does not always have the maximum likelihood as a pixel for correcting the distance relationship information of the correction-target pixel. For this reason, according to this method, there is a problem in that erroneous correction is highly likely to occur.

The invention has been made in order to solve the above-described problems, and an object of the invention is to provide an image processing apparatus, an image processing method, an image processing program, and a multi-eye digital camera having two or more lenses capable of suppressing erroneous correction which easily occurs in the vicinity of the boundary between the foreground and the background and generating a parallax map with high accuracy.

In order to achieve the above-described object, a first aspect of the invention provides an image processing apparatus. The image processing apparatus includes an acquisition unit which acquires a plurality of images captured from two or more different viewpoints, a parallax map generation unit for generating a parallax map in which a parallax represented by a difference between the pixel positions of corresponding pixels of a first image from among a plurality of images acquired by the acquisition unit and a second image captured from a viewpoint different from the first image corresponds with the pixel position of the first image, a histogram generation unit which, from among the pixels of the first image corresponding to an attention pixel of the parallax map generated by the parallax map generation unit and peripheral pixels in the periphery of the attention pixel, extracts pixels having a difference in color information within a predetermined range against the color information of a pixel corresponding to the attention pixel of the parallax map and generates a parallax histogram on the basis of the parallax of each pixel of the parallax map corresponding to each extracted pixel, and a correction unit which corrects the parallax of the attention pixel as a correction target on the basis of the parallax histogram generated by the histogram generation unit.

With the image processing apparatus of the first aspect, the acquisition unit acquires a plurality of images captured from two or more different viewpoints, and the parallax map generation unit generates a parallax map in which a parallax represented by a difference between the pixel positions of corresponding pixels of a first image from among a plurality of images and a second image captured from a viewpoint different from the first image corresponds with the pixel position of the first image. If erroneous correspondence occurs between the first image and the second image, the erroneous correspondence becomes noise on the parallax map.

The histogram generation unit extracts, from among the pixels of the first image corresponding to an attention pixel of the parallax map generated by the parallax map generation unit and peripheral pixels in the periphery of the attention pixel, pixels having a difference in color information from color information of a pixel corresponding to the attention pixel of the parallax map within a predetermined range and generates a parallax histogram on the basis of the parallax of each pixel of the parallax map corresponding to each extracted pixel. The correction unit corrects the parallax of the attention pixel as a correction target on the basis of the parallax histogram generated by the histogram generation unit.

As described above, the parallax of the attention pixel is corrected by using the parallax histogram generated on the basis of the parallax of a pixel having a difference in color information from color information of a pixel corresponding to the attention pixel from among the pixels of the first image corresponding to the attention pixel within a predetermined range, that is, the parallax corresponding to a pixel having similar color information. Therefore, it is possible to suppress erroneous correction which is particularly likely to occur in the vicinity of the boundary between the foreground and the background, generating a parallax map with high accuracy.

A second aspect of the invention provides an image processing apparatus. The image processing apparatus includes an acquisition unit which acquires a plurality of images captured from two or more different viewpoints, a parallax map generation unit for generating a parallax map in which a parallax represented by a difference between the pixel positions of corresponding pixels of a first image from among a plurality of images acquired by the acquisition unit and a second image captured from a viewpoint different from the first image corresponds with the pixel position of the first image, a histogram generation unit which extracts a connection region which includes a pixel of the first image corresponding to an attention pixel of the parallax map generated by the parallax map generation unit and in which adjacent pixels having a difference in color information from color information of a pixel corresponding to the attention pixel of the parallax map within a predetermined range are connected, and generates a parallax histogram on the basis of the parallax of each pixel in the region of the parallax map corresponding to the extracted connection region, and a correction unit which corrects the parallax of the attention pixel as a correction target on the basis of the parallax histogram generated by the histogram generation unit.

With the image processing apparatus of the second aspect, the acquisition unit acquires a plurality of images captured from two or more different viewpoints, and the parallax map generation unit generates a parallax map in which a parallax represented by a difference between the pixel positions of corresponding pixels of a first image from among a plurality of images and a second image captured from a viewpoint different from the first image corresponds with the pixel position of the first image. If erroneous correspondence occurs between the first image and the second image, the erroneous correspondence becomes noise on the parallax map.

The histogram generation unit extracts a connection region which includes a pixel of the first image corresponding to an attention pixel of the parallax map generated by the parallax map generation unit and in which adjacent pixels having a difference in color information from color information of a pixel corresponding to the attention pixel of the parallax map within a predetermined range are connected, and generates a parallax histogram on the basis of the parallax of each pixel in the region of the parallax map corresponding to the extracted connection region. The correction unit corrects the parallax of the attention pixel as a correction target on the basis of the parallax histogram generated by the histogram generation unit.

As described above, the parallax of the attention pixel is corrected by using the parallax histogram generated on the basis of the parallax of each pixel corresponding to the connection region in which adjacent pixels having a difference in color information from color information of a pixel corresponding to the attention pixel from among the pixels of the first image corresponding to the attention pixel, that is, pixels having similar color information are connected. Therefore, it is possible to suppress erroneous correction which is particularly likely to occur in the vicinity of the boundary between the foreground and the background, generating a parallax map with high accuracy.

In the image processing apparatus of the second aspect, when the number of pixels in the connection region is equal to or greater than a predetermined number, the histogram generation unit may generate the parallax histogram. Therefore, it is possible to maintain accuracy of a parallax histogram and to suppress erroneous correction.

In the image processing apparatus of the second aspect, the correction unit may correct the parallax of each pixel in the region of the parallax map corresponding to the connection region. The inside of the connection region can be substantially regarded as the same plane, thus the attention pixel and the pixels corresponding to the connection region are collectively set as a correction target, achieving efficient processing.

In the image processing apparatus of the first or second aspect, when the frequency of the parallax of the attention pixel is smaller than a predefined frequency threshold value, the correction unit may set the attention pixel as a correction target on the basis of the parallax histogram. In this way, when the frequency of the parallax of the attention pixel is in the minority, correction is carried out, and when the frequency of the parallax of the attention pixel is in the majority, correction is not carried out. Therefore, it is possible to detect an appropriate correction-target pixel and to suppress unnecessary correction.

In the image processing apparatus of the first or second aspect, the correction unit may correct the parallax of a correction-target pixel to a parallax having the maximum frequency value of the parallax histogram. Therefore, it is possible to carry out correction with a more reliable parallax, further suppressing erroneous correction which is particularly likely to occur in the vicinity of the boundary between the foreground and the background.

The image processing apparatus of the first or second aspect may further include a determination unit which selects a parallax having a frequency equal to or greater than a predefined selection threshold value as a temporary correction parallax on the basis of the parallax histogram and determines whether or not to correct the parallax of a correction-target pixel with the temporary correction parallax on the basis of color information of a pixel of the second image corresponding to the attention pixel and the attention pixel obtained on the basis of the selected temporary correction parallax. The correction unit may correct the parallax of the correction-target pixel on the basis of the parallax histogram and the determination result of the determination unit.

In this way, it is determined whether or not to correct with the selected temporary correction parallax on the basis of color information of the first image and color information of the second image, making it possible to more accurately suppress erroneous correction which is likely to occur in the vicinity of the boundary between the foreground and the background.

In the image processing apparatus of the first or second aspect, the correction unit may extract, from the parallax map, a parallax connection region which includes the attention pixel and in which adjacent pixels having a difference in parallax from the parallax of the attention pixel within a predetermined range, and when the number of pixels in the extracted parallax connection region is smaller than a predetermined number, may correct the parallax of each pixel in the parallax connection region on the basis of the parallax histogram. In this way, the parallax connection region having the number of pixels smaller than a predetermined number is set as a correction target, making it possible to effectively correct spike-like noise on the parallax map.

A third aspect of the invention provides an image processing apparatus. The image processing apparatus includes an acquisition unit which acquires a plurality of images captured from two or more different viewpoints, a parallax map generation unit which generates a parallax map in which a parallax represented by a difference between the pixel positions of corresponding pixels of a first image from among a plurality of images acquired by the acquisition unit and a second image captured from a viewpoint different from the first image corresponds with the pixel position of the first image, a histogram generation unit which extracts a connection region which includes a pixel of the first image corresponding to an attention pixel of the parallax map generated by the parallax map generation unit and in which adjacent pixels having a difference in color information from color information of a pixel corresponding to the attention pixel of the parallax map within a predetermined range are connected, and when a contour is in the region of the parallax map corresponding to the extracted connection region, generates a parallax histogram on the basis of the parallax of each pixel in the region of the parallax map corresponding to the extracted connection region, and a correction unit which corrects the parallax of each pixel in the region of the parallax map corresponding to the connection region on the basis of the parallax histogram generated by the histogram generation unit.

With the image processing apparatus of the third aspect, the acquisition unit acquires a plurality of images captured from two or more different viewpoints, and the parallax map generation unit generates a parallax map in which a parallax represented by a difference between the pixel positions of corresponding pixels of a first image from among a plurality of images and a second image captured from a viewpoint different from the first image corresponds with the pixel position of the first image. If erroneous correspondence occurs between the first image and the second image, the erroneous correspondence becomes noise on the parallax map.

The histogram generation unit extracts a connection region which includes a pixel of the first image corresponding to an attention pixel of the parallax map generated by the parallax map generation unit and in which adjacent pixels having a difference in color information from color information of a pixel corresponding to the attention pixel of the parallax map within a predetermined range are connected, and when a contour is in the region of the parallax map corresponding to the extracted connection region, generates a parallax histogram on the basis of the parallax of each pixel in the region of the parallax map corresponding to the extracted connection region. The correction unit corrects the parallax of each pixel in the region of the parallax map corresponding to the connection region on the basis of the parallax histogram generated by the histogram generation unit.

In this way, the pixels in the connection region can be substantially regarded as the same plane, thus the contour (difference in parallax) does not intrinsically occur in the region of the parallax map corresponding to the connection region. Therefore, the parallax of each pixel corresponding to the connection region is corrected on the basis of the parallax histogram, making it possible to more effectively correct noise on the parallax map.

A fourth aspect of the invention provides an image processing method. The image processing method includes the steps of acquiring a plurality of images captured from two or more different viewpoints, generating a parallax map in which a parallax represented by a difference between the pixel positions of corresponding pixels of a first image from among a plurality of acquired images and a second image captured from a viewpoint different from the first image corresponds with the pixel position of the first image, from among the pixels of the first image corresponding to an attention pixel of the generated parallax map and peripheral pixels in the periphery of the attention pixel, extracting pixels having a difference in color information from color information of a pixel corresponding to the attention pixel of the parallax map within a predetermined range, generating the parallax histogram on the basis of the parallax of each pixel of the parallax map corresponding to each extracted pixel, and correcting the parallax of the attention pixel as a correction target on the basis of the generated parallax histogram.

A fifth aspect of the invention provides an image processing method. The image processing method includes the steps of acquiring a plurality of images captured from two or more different viewpoints, generating a parallax map in which a parallax represented by a difference between the pixel positions of corresponding pixels of a first image from among a plurality of acquired images and a second image captured from a viewpoint different from the first image corresponds with the pixel position of the first image, extracting a connection region which includes a pixel of the first image corresponding to an attention pixel of the generated parallax map and in which adjacent pixels having a difference in color information from color information of a pixel corresponding to the attention pixel of the parallax map within a predetermined range are connected, and generating a parallax histogram on the basis of the parallax of each pixel in the region of the parallax map corresponding to the extracted connection region, and correcting the parallax of the attention pixel as a correction target on the basis of the generated parallax histogram.

A sixth aspect of the invention provides an image processing program. The image processing program causes a computer to function as an acquisition unit which acquires a plurality of images captured from two or more different viewpoints, a parallax map generation unit which generates a parallax map in which a parallax represented by a difference between the pixel positions of corresponding pixels of a first image from among a plurality of images acquired by the acquisition unit and a second image captured from a viewpoint different from the first image corresponds with the pixel position of the first image, a histogram generation unit which, from among the pixels of the first image corresponding to an attention pixel of the parallax map generated by the parallax map generation unit and peripheral pixels in the periphery of the attention pixel, extracts pixels having a difference in color information from color information of a pixel corresponding to the attention pixel of the parallax map within a predetermined range and generates a parallax histogram on the basis of the parallax of each pixel of the parallax map corresponding to each extracted pixel, and a correction unit which corrects the parallax of the attention pixel as a correction target on the basis of the parallax histogram generated by the histogram generation unit.

A seventh aspect of the invention provides an image processing program. The image processing program causes a computer to function as an acquisition unit which acquires a plurality of images captured from two or more different viewpoints, a parallax map generation unit which generates a parallax map in which a parallax represented by a difference between the pixel positions of corresponding pixels of a first image from among a plurality of images acquired by the acquisition unit and a second image captured from a viewpoint different from the first image corresponds with the pixel position of the first image, a histogram generation unit which extracts a connection region which includes a pixel of the first image corresponding to an attention pixel of the parallax map generated by the parallax map generation unit and in which adjacent pixels having a difference in color information from color information of a pixel corresponding to the attention pixel of the parallax map within a predetermined range are connected, and generates a parallax histogram on the basis of the parallax of each pixel in the region of the parallax map corresponding to the extracted connection region, and a correction unit which corrects the parallax of the attention pixel as a correction target on the basis of the parallax histogram generated by the histogram generation unit.

An eighth aspect of the invention provides a multi-eye digital camera. The multi-eye digital camera includes the image processing apparatus of any one of the first to third aspects, and a display unit which displays an image in stereoscopic view on the basis of a parallax map generated and corrected by the image processing apparatus.

It should be noted that, as color information of a pixel, the RGB value, YCbCr value, LUV value, or brightness value of each pixel can be used.

As described above, according to the aspects of the invention, the parallax of an attention pixel is corrected by using a parallax histogram which is generated on the basis of color information of a first image as an actual image while limiting the entry into a histogram. Therefore, it is possible to suppress erroneous correction which is particularly likely to occur in the vicinity of the boundary between the foreground and the background, thereby generating a parallax map with high accuracy.

### BRIEF DESCRIPTION OF THE DRAWINGS

FIG. 1 is a front perspective view of a twin eye digital camera of this embodiment.

FIG. 2 is a rear perspective view of the twin eye digital camera of this embodiment.

FIG. 3 is a schematic block diagram showing the internal configuration of the twin eye digital camera of this embodiment.

FIG. 4 is a flowchart showing the content of an image processing routine according to a first embodiment.

FIG. 5 is an image view illustrating generation of a parallax map.

FIG. 6 is an image view showing the outline of image processing according to the first embodiment.

FIGS. 7A and 7B are flowcharts showing the content of an image processing routine according to a second embodiment.

FIG. 8 is an image view showing the outline of image processing according to the second embodiment.

FIGS. 9A and 9B are flowchart showing the content of an image processing routine according to a third embodiment.

FIG. 10 is an image view showing the outline of image processing according to the third embodiment.

FIGS. 11A and 11B are flowcharts showing the content of image processing according to a fourth embodiment.

FIG. 12 is an image view showing the outline of image processing according to the fourth embodiment.

FIG. 13 is a flowchart showing the content of an image processing routine according to a fifth embodiment.

FIG. 14 is an image view showing the outline of image processing according to the fifth embodiment.

FIG. 15 is an image view illustrating an intermediate-view image.

### DESCRIPTION OF THE PREFERRED EMBODIMENTS

Hereinafter, embodiments of the invention will be described in detail with reference to the drawings. In the embodiments, a case will be described where an image processing apparatus of the invention is applied to a twin eye digital camera.

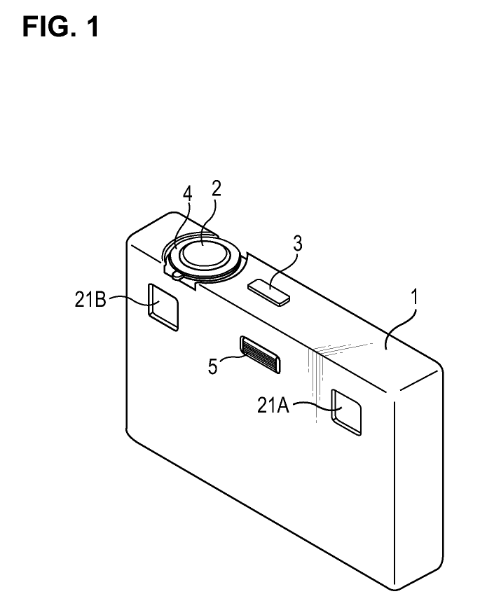

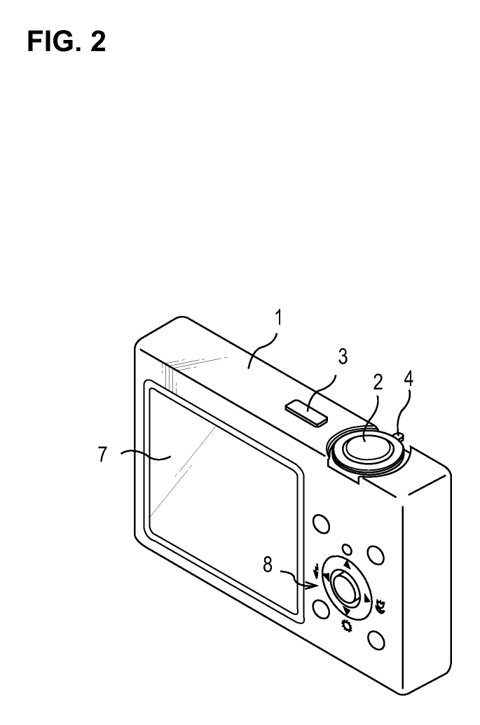

FIG. 1 is a front perspective view of a twin eye digital camera 1 of a first embodiment. FIG. 2 is a rear perspective view. As shown in FIG. 1, in the upper part of the twin eye digital camera 1, a release button 2, a power button 3, and a zoom lever 4 are provided. On the front of the twin eye digital camera 1, a flash 5 and lenses of two photographing units 21A and 21B are provided. On the rear of the twin eye digital camera 1, a liquid crystal monitor 7 which performs various kinds of display and various operation buttons 8 are provided.

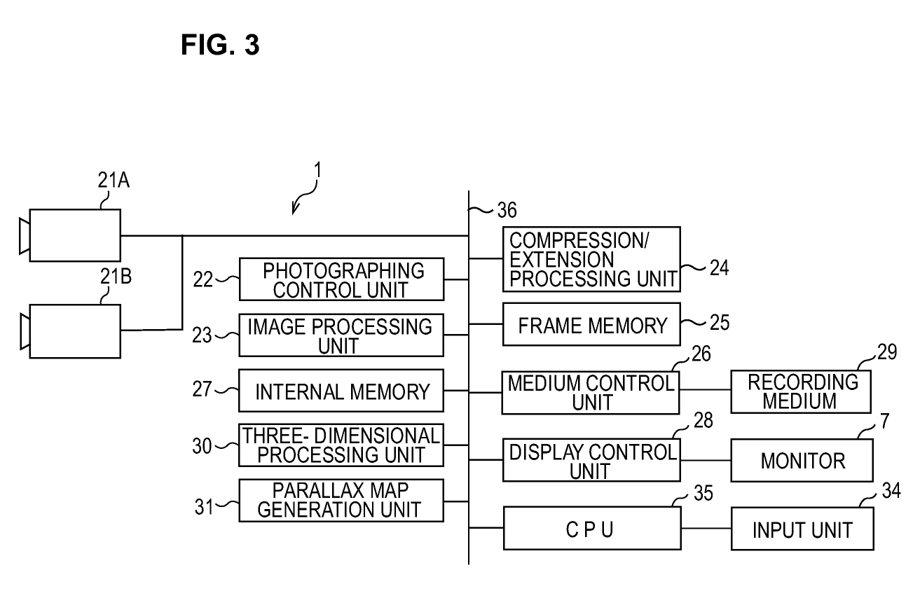

FIG. 3 is a schematic block diagram showing the internal configuration of the twin eye digital camera 1. As shown in FIG. 3, the twin eye digital camera 1 includes two photographing units 21A and 21B, a photographing control unit 22, an image processing unit 23, a compression/extension processing unit 24, a frame memory 25, a medium control unit 26, an internal memory 27, and a display control unit 28. The photographing units 21A and 21B are arranged such that a predefined base line is obtained with a convergence angle at which an object is viewed. Information regarding the convergence angle and the base line is stored in the internal memory 27.

The photographing control unit 22 has an AF processing unit and an AE processing unit (not shown). The AF processing unit determines a focusing region on the basis of pre images obtained by the photographing units 21A and 21B by half push operation of the release button 2, determines the focal positions of the lenses, and outputs the focusing region and the focal positions to the photographing units 21A and 21B. The AE processing unit determines an aperture value and a shutter speed on the basis of the pre images and outputs the aperture value and the shutter speed to the photographing units 21A and 21B.

The photographing control unit 22 instructs normal photographing by a full push operation of the release button 2 such that the photographing unit 21A acquires the normal image of a left image and the photographing unit 21B acquires the normal image of a right image. Before the release button 2 is operated, the photographing control unit 22 instructs the photographing units 21A and 21B to sequentially acquire through images having a smaller number of pixels than the normal image at a predetermined time interval (for example, an interval of 1/30 seconds) so as to confirm a photographing range.

The image processing unit 23 performs image processing, such as processing for adjusting white balance, gradation correction, sharpness correction, and color correction, for digital image data of the left and right images acquired by the photographing units 21A and 21B.

The compression/extension processing unit 24 performs compression processing for image data representing the left and right images processed by the image processing unit 23 in a compression format of, for example, JPEG or the like to generate an image file for stereoscopic view. The image file for stereoscopic view includes image data of the left and right images, and stores incidental information, such as the base line, the convergence angle, and the photographing date, and viewpoint information representing a viewpoint position on the basis of an Exif format or the like.

The frame memory 25 is a work memory which is used when various kinds of processing including the above-described processing in the image processing unit 23 are performed on image data representing the left and right images acquired by the photographing units 21A and 21B.

The medium control unit 26 accesses a recording medium 29 and controls writing and reading of an image file or the like.

The internal memory 27 stores various constants which are set in the twin eye digital camera 1, a program which is executed by the CPU 35, and the like.

The display control unit 28 controls the liquid crystal monitor 7 to display an image for stereoscopic view generated from the left and right images stored in the frame memory 25 at the time of photographing or controls the liquid crystal monitor 7 to display the left and right images or an image for stereoscopic view recorded in the recording medium 29.

The twin eye digital camera 1 includes a three-dimensional processing unit 30 and a parallax map generation unit 31.

The three-dimensional processing unit 30 performs three-dimensional processing for the left and right images to generate an image for stereoscopic view such that the left and right images are displayed on the monitor 7 in stereoscopic view.

The parallax map generation unit 31 generates a parallax map based on the left and right images so as to obtain appropriate stereoscopic effect of the image for stereoscopic view, and corrects the parallax map through processing described below. A parallax can be calculated as a difference between the pixel positions in the lateral direction of the left and right images of an object in the left and right images. A parallax map is appropriately generated and corrected, making it possible to obtain an appropriate stereoscopic effect of the object in the image for stereoscopic view.

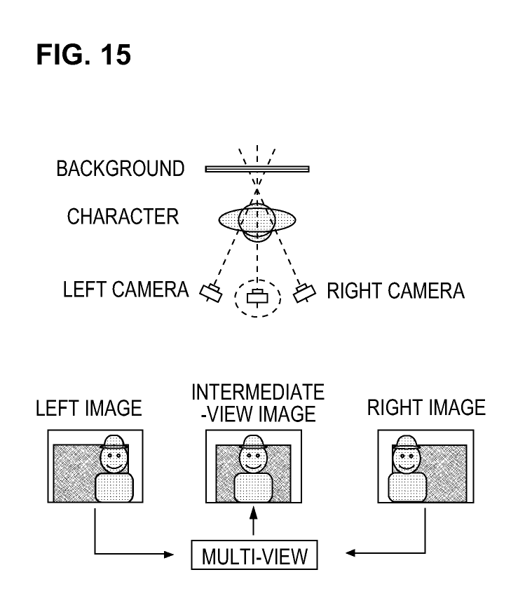

Specifically, if a parallax map is appropriately generated, it is possible to generate an intermediate-view image by using the parallax map. As shown in FIG. 15, an intermediate-view image is an image which is virtually generated from a viewpoint (a viewpoint indicated by a broken-line circle in FIG. 15) at an intermediate position between the left camera (left viewpoint) and a right camera (right viewpoint) of a twin eye camera. For example, if it is understood from a parallax map that a parallax which occurs between a left image from a left viewpoint and a right image from a right viewpoint is excessively large, an intermediate-view image may be generated on the basis of the left image, the right image, and the parallax map, and stereoscopic display may be performed by using the left image and the intermediate-view image. Thus, it is possible to acquire an image in which the base line is just half, obtaining an appropriate stereoscopic effect of the image for stereoscopic view.

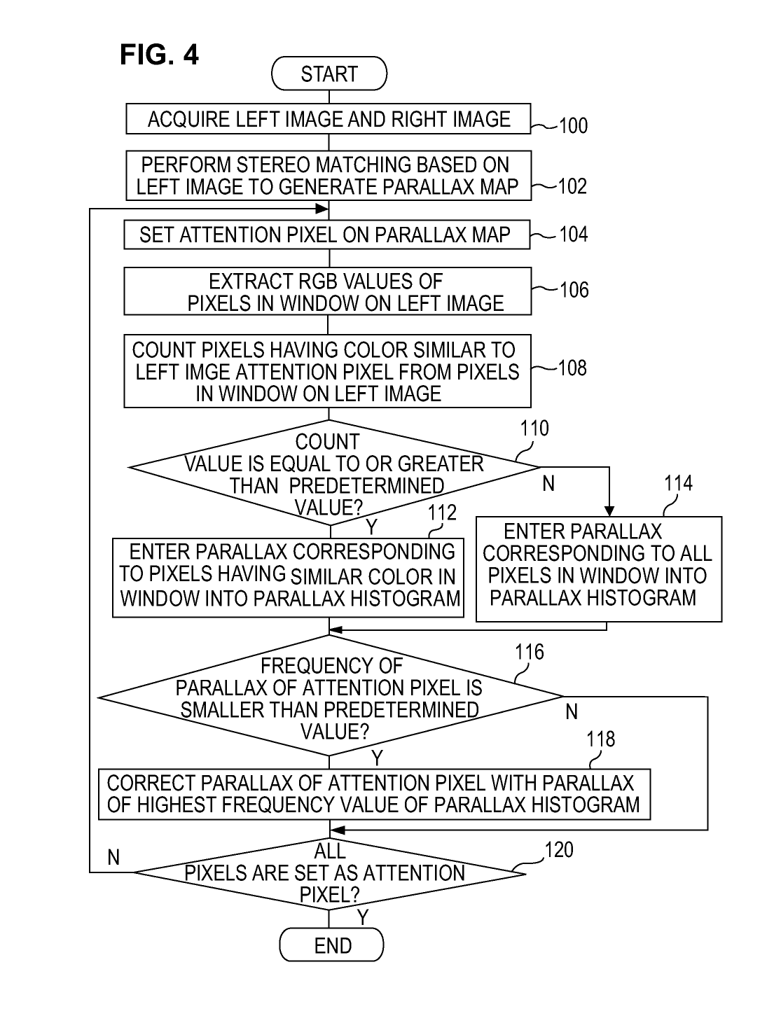

Next, an image processing routine in the twin eye digital camera of the first embodiment will be described with reference to FIG. 4.

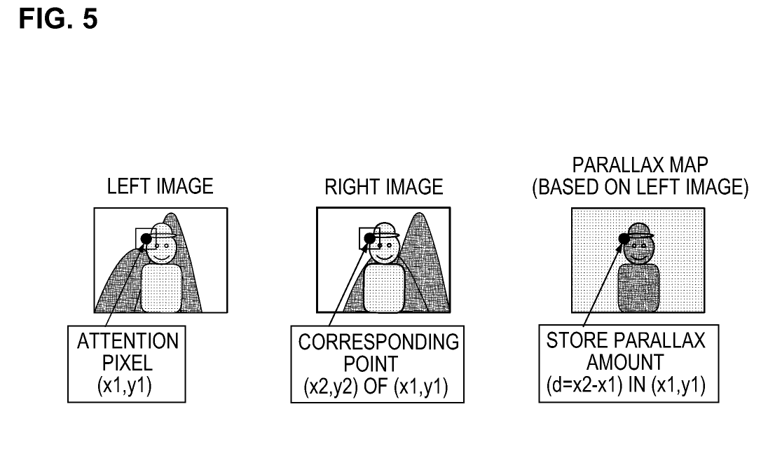

In Step 100, the left and right images captured by the photographing units 21A and 21B are acquired. Next, in Step 102, stereo matching is carried out for the left and right images to generate a parallax map. Specifically, as shown in FIG. 5, a corresponding pixel (x2,y2) on the right image corresponding to a pixel (x1,y1) on the left image is extracted through stereo matching. Here, description will be provided assuming that a parallax is generated in the lateral direction (horizontal direction) of an image, and no deviation occurs in the longitudinal direction (vertical direction). the parallax d between the pixel (x1,y1) on the left image and the corresponding pixel (x2,y2) on the right image can be computed as d=x2−x1, and the parallax d is stored at the pixel position (x1,y1) of the left image as the base. The parallax d which is computed for each pixel of the left image is stored in correspondence with the pixel position of the left image to create an image. The created image is called a parallax map.

Next, in Step 104, an attention pixel (hereinafter, an attention pixel on the parallax map is also simply referred to as an attention pixel) is set on the parallax map. For example, a pixel at the upper left corner of the parallax map is set as an initial attention pixel. Subsequently, each pixel in a raster scanning order is set as an attention pixel.

Next, in Step 106, a window of a predetermined size is set which includes a pixel (hereinafter, referred to as a left image attention pixel) on the left image corresponding to the pixel position of the attention pixel and peripheral pixels in the periphery of the left image attention pixel. A window may be, for example, of a size in a range of peripheral n×n pixels (where n is an integer, for example, 13×13 pixels) centering on the left image attention pixel. The RGB value of each pixel in the window on the left image is extracted.

Next, in Step 108, from among the peripheral pixels in the window on the left image, the number of pixels having an RGB value similar to the RGB value of the left image attention pixel is counted. The similar RGB value represents that the left image attention pixel and the peripheral pixels have similar colors. Here, when a difference in the RGB value from the RGB value of the left image attention pixel is within a predetermined range, it is determined that relevant pixels have similar colors. For example, if the RGB value of the left image attention pixel is (r0,g0,b0) and the RGB value of a peripheral pixel for comparison is (r,g,b), it is determined whether or not the pixels have similar colors by the following expression (1).

$$\begin{matrix}if \sqrt{\begin{matrix}{( r - {r}_{0} )}^{2} + \\ {( g - {g}_{0} )}^{2} + {( b - {b}_{0} )}^{2}\end{matrix}} \leq color\_thres \to similarcolors \\ else \to notsimilarcolors\end{matrix} \} \qquad [ Equation 1 ]$$

Here, color_thres is a threshold value, and when the RGB value has 256 gradations, color_thres can be set to, for example, about 30. Although a case has been described where the RGB value is used as color information, for example, another color space, such as YCbCr or LUV, may be used, or a brightness value may be used.

Next, in Step 110, it is determined whether or not the counter value of pixels having a similar color to the left image attention pixel in the window is equal to or greater than a predetermined value. When the counter value is small, that is, when the number of similar colors to the left image attention pixel is small, the number of entries into a parallax histogram described below decreases, causing deterioration in accuracy of the parallax histogram. For this reason, the counter value is checked. The predetermined value is predefined on the basis of the size of the window or accuracy necessary for a histogram. The predetermined value may be defined as the ratio to all the pixels in the window. For example, when there are pixels having similar colors equal to or greater than 20 percent to the number of pixels in the window (n×n pixels), if there arises no problem regarding accuracy of a histogram, the predetermined value may be defined as n×n×0.2. When the counter value is equal to or greater than the predetermined value, the process progresses to Step 112, and when the counter value is smaller than the predetermined value, the process progresses to Step 114.

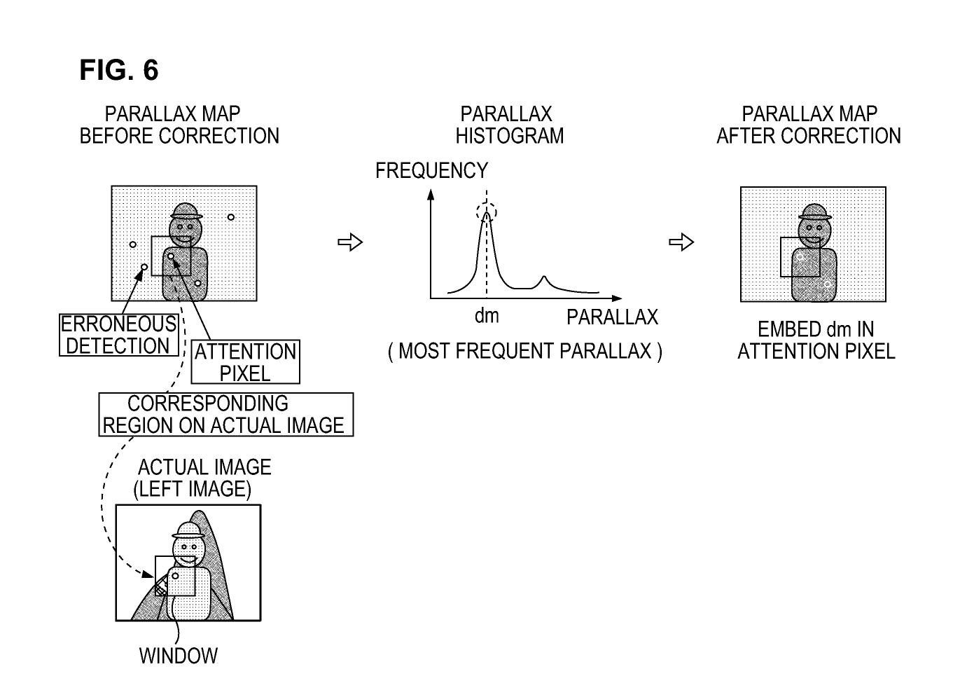

In Step 112, the parallax of each pixel on the parallax map corresponding to the pixels having similar colors to the left image attention pixel in the window is entered into a parallax histogram to generate a parallax histogram. FIG. 6 shows an example of a parallax histogram. As shown in FIG. 6, the situation that RGB values are similar on an actual image (in this case, a left image) is considered that an object represented by pixels in a region where a window is set is substantially on the same plane. A parallax corresponding to each of the pixels is entered to generate a parallax histogram, such that in selecting a parallax for correction on the basis of a parallax histogram through processing described below, an appropriate parallax can be selected. Meanwhile, in Step 114, the parallax of each pixel on the parallax map corresponding to all the pixels in the window is entered into a parallax histogram to generate a parallax histogram.

Next, in Step 116, it is determined whether or not the frequency of a parallax di of the attention pixel is smaller than a predefined frequency threshold value freq_thres on the basis of the generated parallax histogram, thereby determining whether or not the parallax di of the attention pixel from among the parallaxes entered into the parallax histogram is in the minority. The frequency threshold value freq_thres can be defined as the ratio to the number of entries in the parallax histogram. For example, when the parallax di of the attention pixel is in the minority if the frequency is smaller than 30 percent of the number N of entries, the frequency threshold value freq_thres=N×0.3 can be defined. When the relationship di<freq_thres is established, it is determined that the parallax di of the attention pixel is in the minority, that is, noise is highly likely to occur, and the process progresses to Step 118. Meanwhile, when the relationship di≧freq_thres is established, it is determined that the parallax di of the attention pixel is in the majority and correction is not required, the process skips Step 118 and progresses to Step 120.

In Step 118, a parallax dm having the maximum frequency value is selected from the parallax histogram, and the parallax dm having the maximum frequency value is corrected to the parallax of the attention pixel. That is, the parallax of the attention pixel is filled with the parallax in the majority.

Next, in Step 120, it is determined whether or not all the pixels on the parallax map are set as an attention pixel. When there remains a pixel which has not been set as an attention pixel, the process returns to Step 104, the next pixel is set as an attention pixel, and the processing is repeated. When there remains no pixel which has not yet been set as an attention pixel, the processing ends.

As described above, according to the twin eye digital camera of the first embodiment, the parallax corresponding to each pixel having a similar color from among the pixels on the actual image corresponding to the attention pixel is entered to generate the parallax map, and the parallax of the attention pixel as a correction target is corrected with the maximum frequency value of the parallax map. Thus, it is possible to suppress erroneous correction which is particularly likely to occur in the vicinity of the boundary between the foreground and the background and to generate a parallax map with high accuracy.

Although in the first embodiment, a case has been described where the parallax of the attention pixel is corrected with the maximum frequency value of the parallax histogram, when there are a plurality of parallaxes having a frequency equal to or greater than a predetermined value which are regarded as being in the majority, correction may be carried out by using one selected parallax. In selecting a parallax, a parallax with many pixels at a pixel position near the pixel position of the attention pixel entered or a parallax with pixels having more similar color information entered can be used.

Next, a second embodiment will be described. The configuration of a twin eye digital camera of the second embodiment is the same as the twin eye digital camera 1 of the first embodiment, thus description thereof will be omitted.

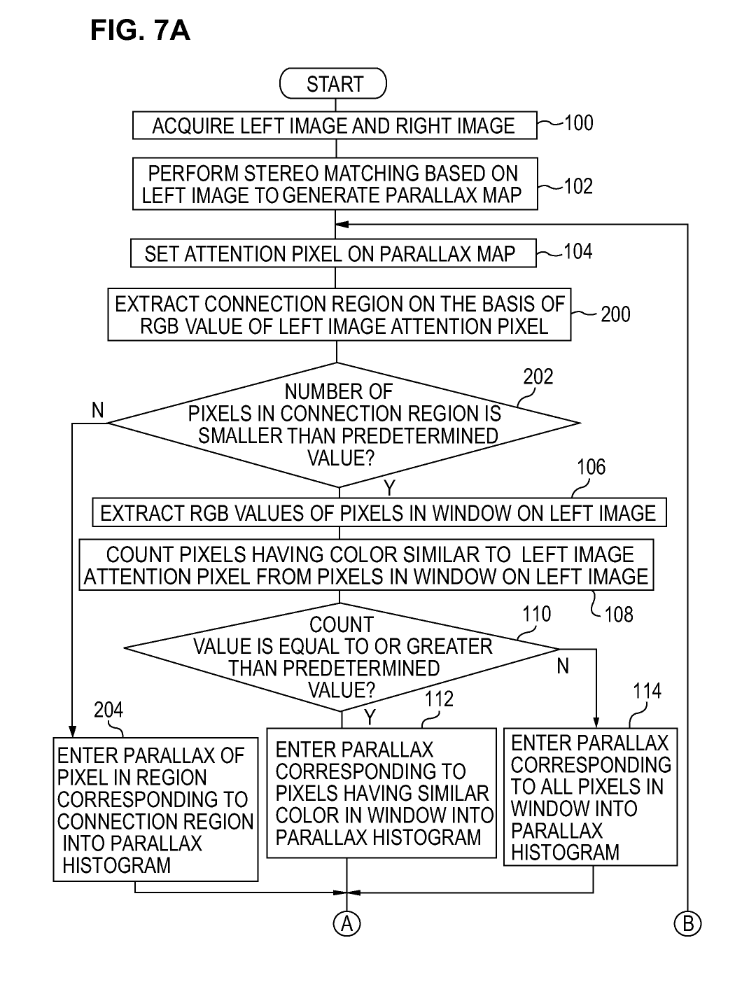

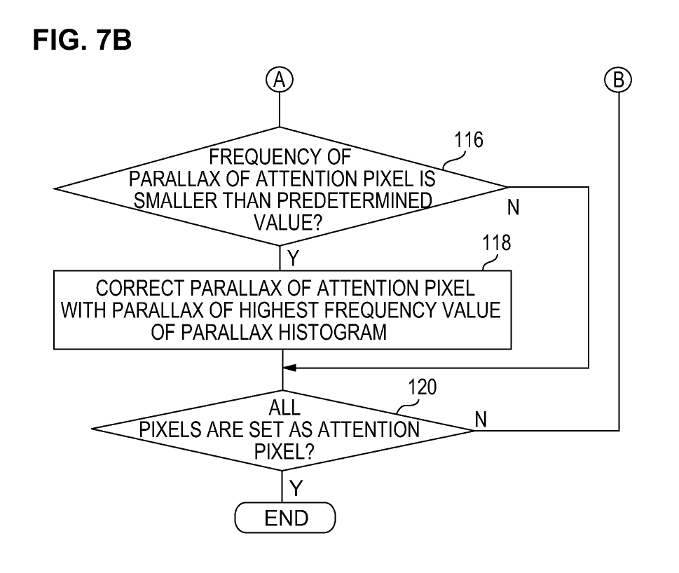

An image processing routine in the twin eye digital camera of the second embodiment will be described with reference to FIGS. 7A and 7B. The same steps as those in the image processing routine of the first embodiment are represented by the same reference numerals, and description thereof will be omitted.

In Steps 100 to 104, a parallax map is generated, and an attention pixel is set on the parallax map.

Next, in Step 200, a connection region which includes the left image attention pixel and which pixels having an RGB value similar to the RGB value of the left image attention pixel, that is, adjacent pixels having a color similar to the left image attention pixel are connected is extracted on the basis of the RGB value of the left image attention pixel. Determination on whether or not the RGB values are similar is done, for example, by using the expression (1), as in the first embodiment.

Next, in Step 202, it is determined whether or not the number of pixels in the connection region is smaller than a predetermined value. When the number of pixels is small, that is, when the number of colors similar to the left image attention pixel is small, the number of entries into the parallax histogram decreases and accuracy of the parallax histogram is deteriorated. Thus, the number of pixels is checked. The predetermined value is predefined on the basis of accuracy necessary for a histogram or the like. The predetermined value can be defined as the ratio to the number of pixels of the entire left image. For example, when there are pixels equal to or greater than 10 percent with respect to the number of pixels of the entire left image, if there arises no problem regarding accuracy of a histogram, the predetermined value can be defined as the total number of pixels×0.1%.

When the number of pixels in the connection region is smaller than the predetermined value, in the case of a parallax histogram with the parallax corresponding to each pixel in the connection region entered, it is determined that accuracy is deteriorated. Then, the process progresses to Step 106, and as in the first embodiment, a parallax histogram is generated by using the parallaxes corresponding to pixels having similar colors within a window or the parallaxes corresponding to all the pixels within the window.

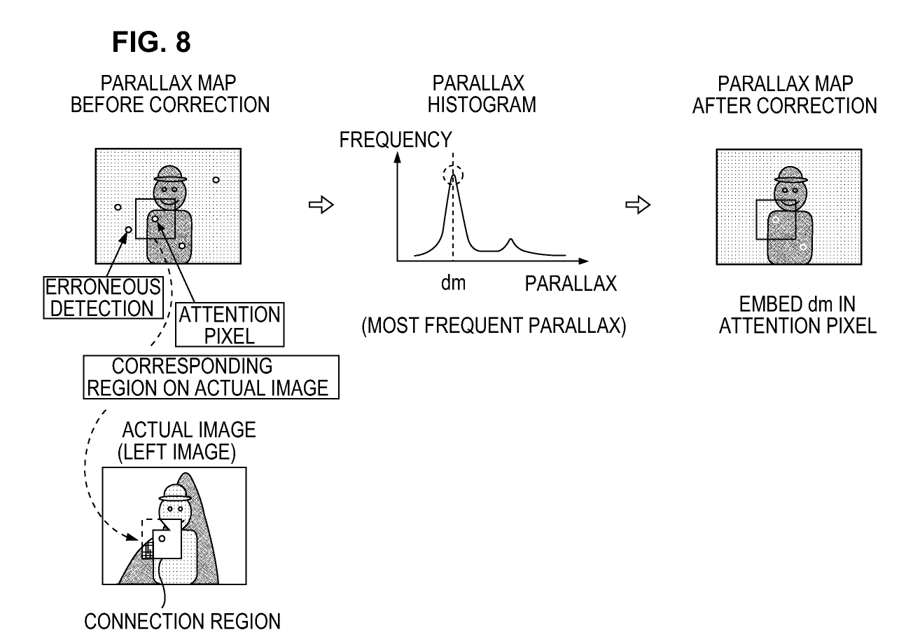

Meanwhile, when the number of pixels in the connection region is equal to or greater than the predetermined value, the process progresses to Step 204, and the parallax of each pixel in the region of the parallax map corresponding to the connection region is entered into a parallax histogram to generate a parallax histogram. FIG. 8 shows an example of a parallax histogram. As shown in FIG. 8, in the connection region in which pixels having similar colors on an actual image (in this case, a left image) are connected, it is considered that an object represented by the pixels in the connection region is substantially on the same plane. A parallax corresponding to each of the pixels is entered to generate a parallax histogram. Thus, in selecting a parallax for correction on the basis of the parallax histogram, it is possible to select an appropriate parallax.

Subsequently, processing is performed in the same manner as in the first embodiment.

As described above, according to the twin eye digital camera of the second embodiment, the parallax corresponding each pixel in the connection region, in which adjacent pixels having similar colors from among the pixels on the actual image corresponding to the attention pixel is entered to generate the parallax map, and the parallax of the attention pixel as a correction target is corrected with the maximum frequency value of the parallax map. Thus, it is possible to suppress which is particularly likely to occur in the vicinity of the boundary between the foreground and the background and to generate a parallax map with high accuracy.

Although in the second embodiment, a case has been described where only the parallax of the attention pixel is corrected with the parallax having the maximum frequency value of the parallax histogram, the pixels in the connection region more strongly tend to substantially represent an object on the same plane, such that not only the attention pixel but also the pixels in the region of the parallax map corresponding to the connection region may be corrected with the parallax having the maximum frequency value of the parallax histogram. Thus, it is possible to achieve efficient processing.

Next, a third embodiment will be described. The configuration of a twin eye digital camera of the third embodiment is the same as the twin eye digital camera 1 of the first embodiment, and description thereof will be omitted.

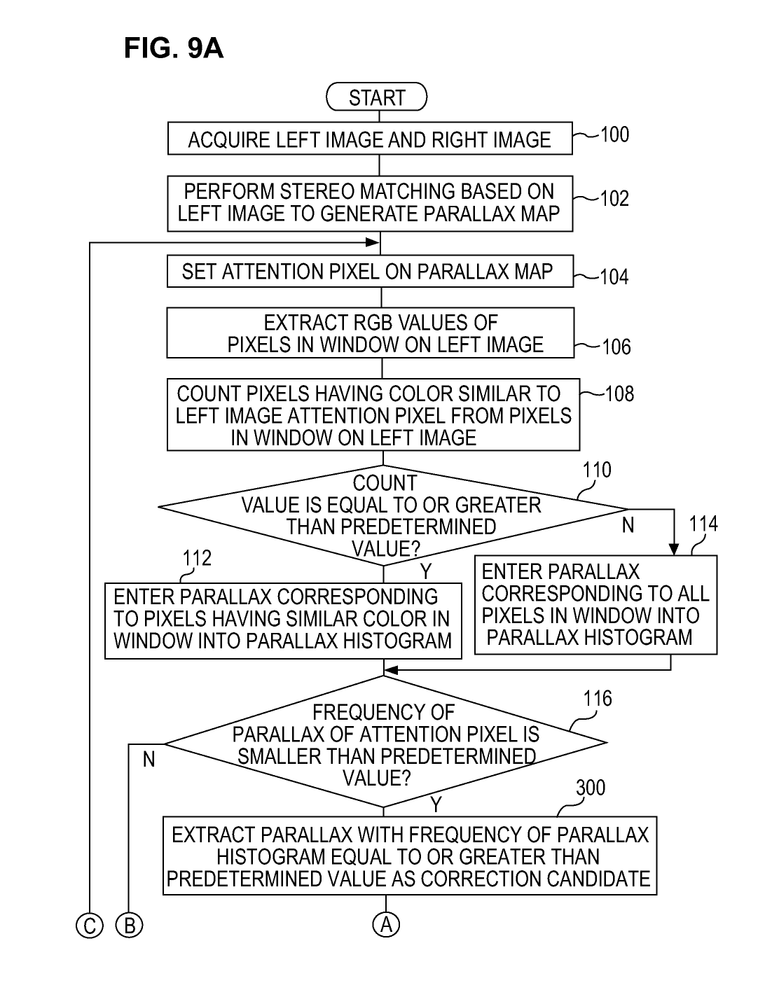

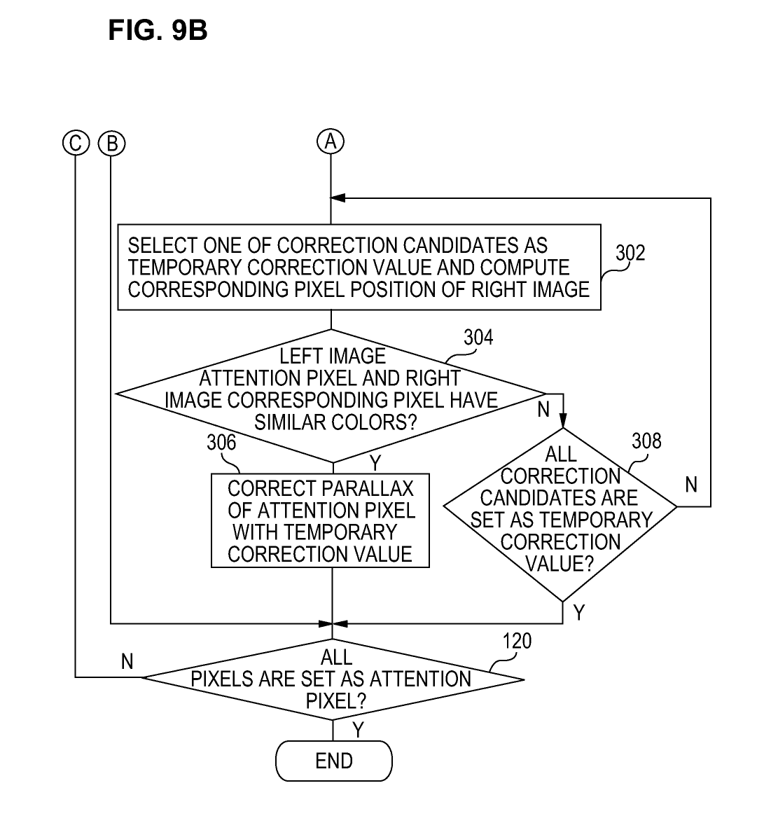

An image processing routine in the twin eye digital camera of the third embodiment will be described with reference to FIGS. 9A and 9B. The same steps as those in the image processing routine of the first embodiment are represented by the same reference numerals, and description thereof will be omitted.

After Steps 100 to 114, in Step 116, it is determined whether or not the frequency of the parallax di of the attention pixel is smaller than the predefined frequency threshold value freq_thres, that is, whether or not the parallax of the attention pixel should be corrected. When it is determined that the relationship di<freq_thres is established, the process progresses to Step 300.

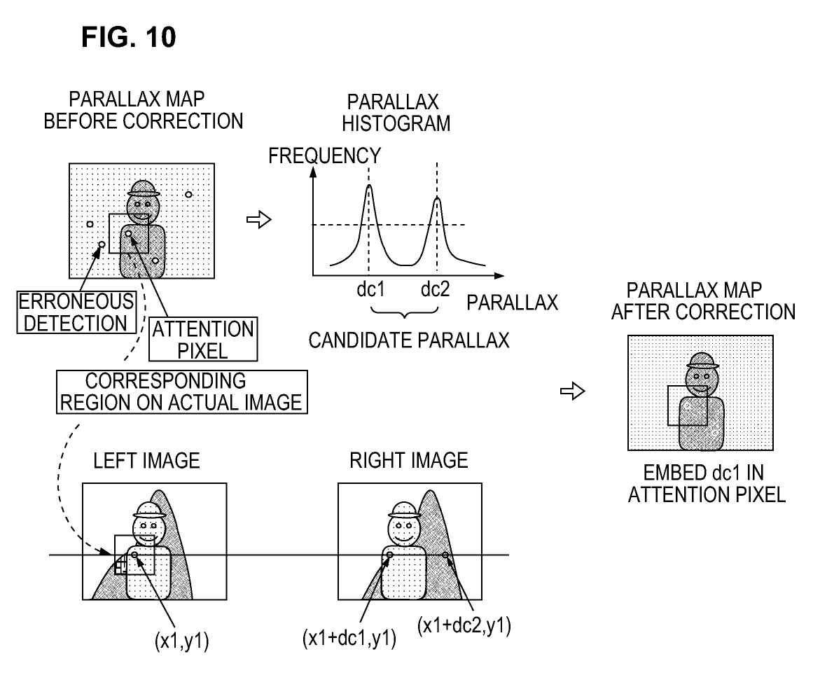

In Step 300, a parallax having a frequency equal to or greater than a predetermined value in the parallax histogram is extracted as a correction candidate. For example, as shown in FIG. 10, when there are two frequencies (dc1, dc2) equal to or greater than a predetermined threshold value in the parallax histogram, these parallaxes are extracted as a correction candidate.

Next, in Step 302, one of the correction candidates is selected and set as a temporary correction value, and the corresponding pixel position of the right image is computed. In selecting one of a plurality of correction candidates, a correction candidate having a higher frequency of the parallax histogram may be selected. First, when the parallax dc1 is selected and set as a temporary correction value, if the pixel position of the left image attention pixel is (x1,y1), the corresponding pixel position of the right image can be computed as (x1+dc1,y1).

Next, in Step 304, the RGB value of the left image attention pixel is compared with the RGB of the corresponding pixel of the right image to determine whether or not both pixels have similar colors. Determination on whether or not both pixels have similar colors is done by using the expression (1), as in the first embodiment. When both pixels have similar colors, it is determined that there is high certainty that the correspondence between the left image and the right image will be correct if correction is carried out with the temporary correction value. Then, the process progresses to Step 306, and the parallax of the attention pixel is corrected with the temporary correction value.

Meanwhile, when both pixels do not have similar colors, it is determined that there is low certainty that the correspondence between the left image and the right image will be correct if correction is carried out with the temporary correction value. Then, the process progresses to Step 308. For example, in the example of FIG. 10, when dc2 is selected as a temporary correction value, the corresponding pixel position of the right image can be computed as (x1+dc2,y1). In this case, it can be understood that the pixel on the character of the left image corresponds to the pixel on the background of the right image and the RGB values of both pixels are significantly different, such that it is not appropriate to carry out correction using the temporary correction value dc2.

In Step 308, it is determined whether or not all the extracted correction candidates are selected as a temporary correction value. When there is a correction candidate which has not yet been selected as a temporary correction value, the process returns to 302, the next temporary value is selected, and the processing is repeated. Meanwhile, when it is determined that all the correction candidates are selected as a temporary correction value, it is determined that an appropriate correction value is not obtained from the parallax histogram, and correction is not carried out for the parallax of the current attention pixel. Then, the process progresses to Step 120.

Subsequently, processing is performed in the same manner as in the first embodiment.

As described above, according to the twin eye digital camera of the third embodiment, the corresponding pixel position of the right image is computed with the parallax having a frequency equal to or greater than a predetermined value in the parallax histogram as a temporary correction value, and it is determined whether or not both corresponding pixels of the left image and the right image have similar colors, thereby determining whether or not to correct the parallax of the attention pixel by using the temporary correction value. Thus, it is possible to suppress erroneous correction which is particularly likely to occur in the vicinity of the boundary between the foreground and the background and to generate a parallax map with high accuracy.

Although in the third embodiment, Step 118 in the image processing routine of the first embodiment is substituted with Steps 300 to 308, similarly, Step 118 in the image processing routine of the second embodiment may be substituted with Steps 300 to 308.

Next, a fourth embodiment will be described. The configuration of a twin eye digital camera of the fourth embodiment is the same as the twin eye digital camera 1 of the first embodiment, thus description thereof will be omitted.

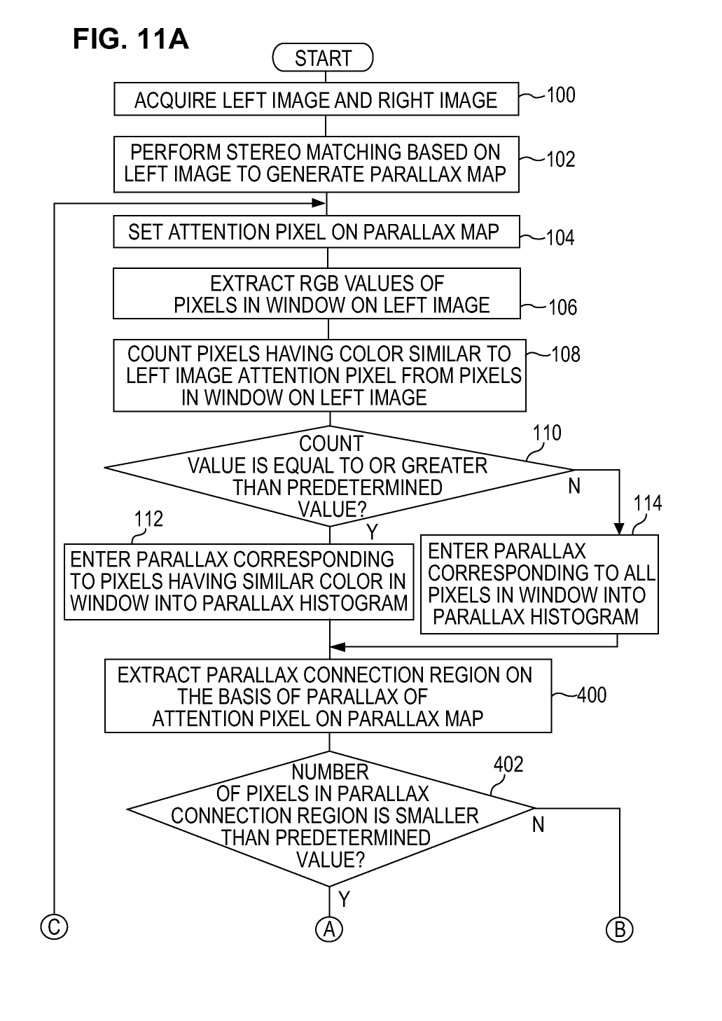

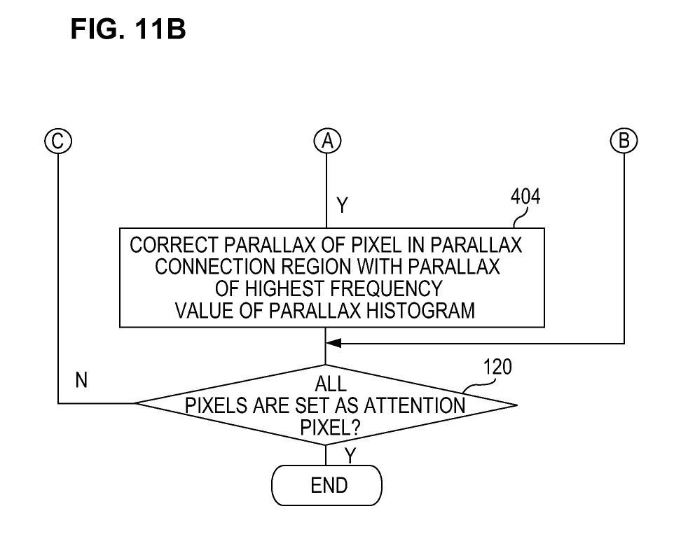

An image processing routine in the twin eye digital camera of the fourth embodiment will be described with reference to FIGS. 11A and 11B. The same steps as those in the image processing routine of the first embodiment are represented by the same reference numerals, and description thereof will be omitted.

After Steps 100 to 114, in Step 400, a parallax connection region which includes an attention pixel and in which adjacent pixels having a difference in a parallax from the parallax of the attention pixel within a predetermined range are connected is extracted from the parallax map.

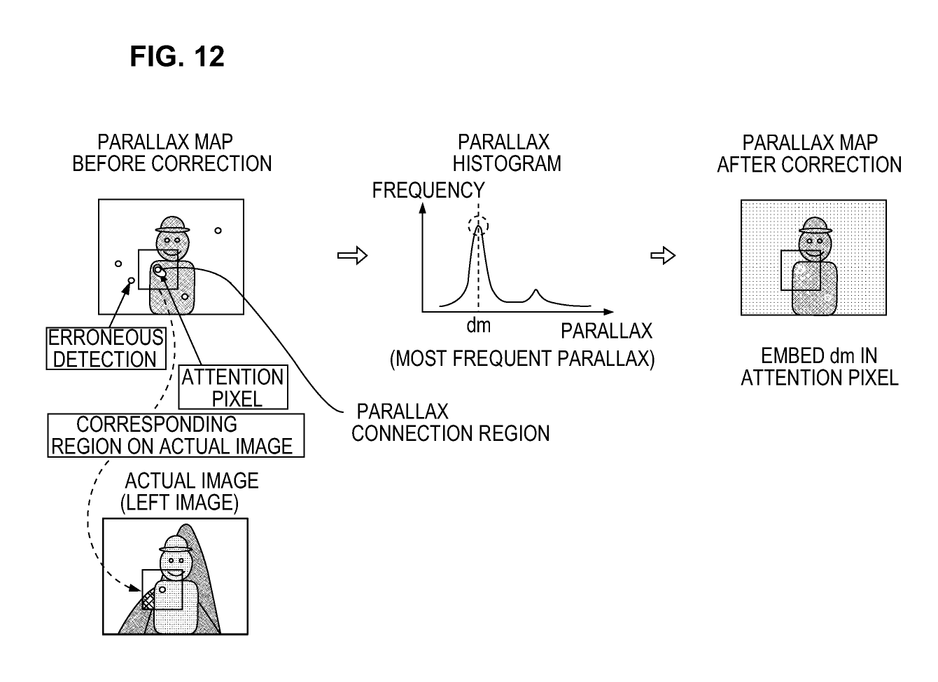

Next, in Step 402, it is determined whether or not the number of pixels in the parallax connection region is smaller than a predetermined value. As shown in FIG. 12, when the area (the number of pixels) of the parallax connection region is small, it is considered that the parallax connection region is spike-like noise. The predetermined value can be defined to, for example, a value corresponding to 0.5 to 1% of the number of pixels of the entire parallax map. When the number of pixels in the parallax connection region is smaller than the predetermined value, the process progresses to Step 404. When the number of pixels in the parallax connection region is equal to or greater than the predetermined value, the process skips Step 404 and progresses to Step 120.

In Step 404, the parallax of each pixel in the parallax connection region is corrected with the maximum frequency value of the parallax histogram.

Subsequently, processing is performed in the same manner as in the first embodiment.

As described above, according to the twin eye digital camera of the fourth embodiment, the parallax connection region is extracted from the parallax map, when the number of pixels in the parallax connection region is smaller than a predetermined value, the parallax connection region is regarded as spike-like noise, and the parallax of each pixel in the parallax connection region is corrected with the maximum frequency value of the parallax histogram, making it possible to accurately generate a parallax map. In particular, it is possible to reduce spike-like noise on the parallax map.

Although in the fourth embodiment, Steps 116 and 118 in the image processing routine of the first embodiment are substituted with Steps 400 to 304, similarly, Steps 116 and 118 in the image processing routine of the second embodiment may be substituted with Steps 300 to 308. The fourth embodiment may be combined with the first to third embodiments.

Next, a fifth embodiment will be described. The configuration of a twin eye digital camera of the fifth embodiment is the same as the twin eye digital camera 1 of the first embodiment, thus description thereof will be omitted.

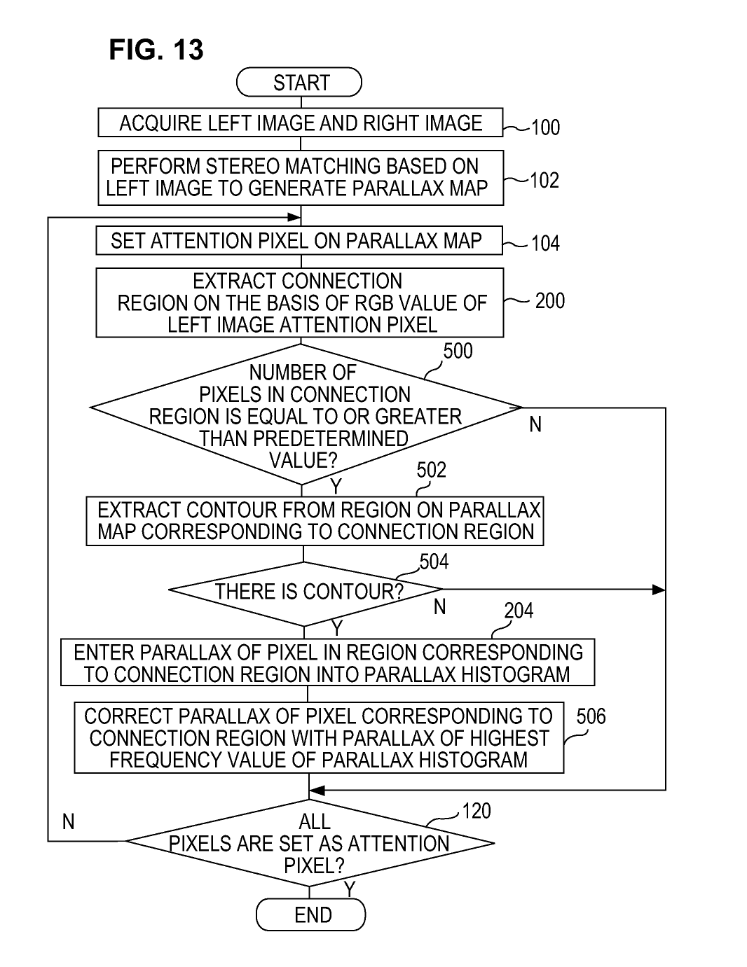

An image processing routine in the twin eye digital camera of the fifth embodiment will be described with reference to FIG. 13. The same steps as those in the image processing routines of the first and second embodiments are represented by the same reference numerals, and description thereof will be omitted.

Through Steps 100 to 104 and Step 200, a connection region is extracted from the left image. Next, in Step 500, it is determined whether or not the number of pixels in the connection region is equal to or greater than a predetermined value. When the number of pixels in the connection region is equal to or greater than the predetermined value, the process progresses to Step 502. When the number of pixels in the connection region is smaller than the predetermined value, the process progresses to Step 120.

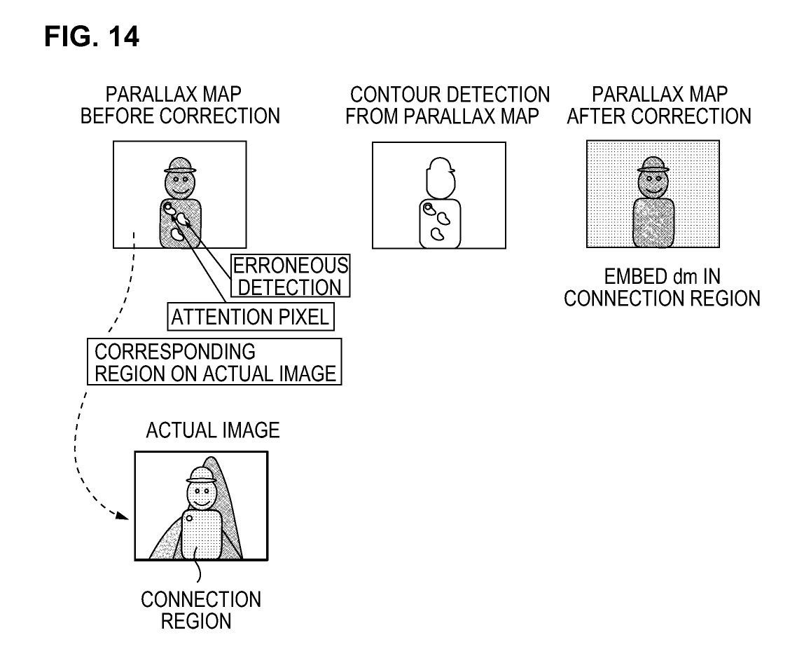

In Step 502, as shown in FIG. 14, high-pass processing, band-pass processing, or the like is performed for the region on the parallax map corresponding to the connection region to extract a contour. Next, in Step 504, it is determined whether or not a contour is extracted. It is considered that the object represented by the pixels in the connection region in which pixels having similar colors are connected is substantially on the same plane. For this reason, usually, there is no case where a difference in parallax occurs on the parallax map corresponding to the connection region. Thus, when a contour exists, it is determined to be noise, and the contour is set as a correction target. When a counter exists, the process progresses to Step 204.

In Step 204, the parallax of each pixel in the region of the parallax map corresponding to the connection region is entered into a parallax histogram to generate a parallax histogram. Next, in Step 506, the parallax of each pixel in the region of the parallax map corresponding to the connection region is corrected with the parallax having the maximum frequency value of the parallax histogram.

Subsequently, processing is performed in the same manner as in the first embodiment.

As described above, according to the twin eye digital camera of the fifth embodiment, when a contour exists in the region of the parallax map corresponding to the connection region, the parallax of each pixel in the region of the parallax map corresponding to the connection region is corrected with the maximum frequency value of the parallax histogram. Thus, it is possible to effectively detect a noise region and to accurately generate a parallax map.

Although in the first to fifth embodiments, a case has been described where stereo matching based on the left image is carried out for the left image and the right image to generate a parallax map, stereo matching may be based on the right image.

When three or more images are acquired, one image may set as a first image (standard image), other images may be set as a second image, and a parallax map may be generated for each of the first and second images.

The image processing routine of each of the first to fifth embodiments may be embodied as a program, and the program may be executed by a CPU.

What is claimed is:

1. An image processing apparatus comprising:
an acquisition unit which acquires a plurality of images captured from two or more different viewpoints;
a parallax map generation unit for generating a parallax map in which a parallax represented by a difference between the pixel positions of corresponding pixels of a first image from among a plurality of images acquired by the acquisition unit and a second image captured from a viewpoint different from the first image corresponds with the pixel position of the first image;
a histogram generation unit which, from among the pixels of the first image corresponding to an attention pixel of the parallax map generated by the parallax map generation unit and peripheral pixels in the periphery of the attention pixel, extracts pixels having a difference in color information from color information of a pixel corresponding to the attention pixel of the parallax map, the difference being within a predetermined range and generates a parallax histogram on the basis of the parallax of each pixel of the parallax map corresponding to each extracted pixel; and
a correction unit which corrects the parallax of the attention pixel as a correction target on the basis of the parallax histogram generated by the histogram generation unit.

2. The image processing apparatus according to claim 1,
wherein the histogram generation unit extracts a connection region which includes a pixel of the first image corresponding to an attention pixel of the parallax map generated by the parallax map generation unit and in which adjacent pixels having a difference in color information from color information of a pixel corresponding to the attention pixel of the parallax map within a predetermined range are connected, and generates a parallax histogram on the basis of the parallax of each pixel in the region of the parallax map corresponding to the extracted connection region.

3. The image processing apparatus according to claim 2,
wherein, when the number of pixels in the connection region is equal to or greater than a predetermined number, the histogram generation unit generates the parallax histogram.

4. The image processing apparatus according to claim 2,
wherein the correction unit corrects the parallax of each pixel in the region of the parallax map corresponding to the connection region.

5. The image processing apparatus according to claim 1,
wherein, when the frequency of the parallax of the attention pixel is smaller than a predefined frequency threshold value, the correction unit sets the attention pixel as a correction target on the basis of the parallax histogram.

6. The image processing apparatus according to claim 1,
wherein the correction unit corrects the parallax of each correction-target pixel to a parallax having the maximum frequency value of the parallax histogram.

7. The image processing apparatus according to claim 1, further comprising:
a determination unit which selects a parallax having a frequency equal to or greater than a predefined selection threshold value as a temporary correction parallax on the basis of the parallax histogram and determines whether or not to correct the parallax of a correction-target pixel with the temporary correction parallax on the basis of color information of a pixel of the second image corresponding to the attention pixel and the attention pixel obtained on the basis of the selected temporary correction parallax,
wherein the correction unit corrects the parallax of the correction-target pixel on the basis of the parallax histogram and the determination result of the determination unit.

8. The image processing apparatus according to claim 1,
wherein the correction unit extracts, from the parallax map, a parallax connection region which includes the attention pixel and in which adjacent pixels having a difference in parallax from the parallax of the attention pixel within a predetermined range, and when the number of pixels in the extracted parallax connection region is smaller than a predetermined number, corrects the parallax of each pixel in the parallax connection region on the basis of the parallax histogram.

9. The image processing apparatus according to claim 2,
wherein the histogram generation unit extracts a connection region which includes a pixel of the first image corresponding to an attention pixel of the parallax map generated by the parallax map generation unit and in which adjacent pixels having a difference in color information from color information of a pixel corresponding to the attention pixel of the parallax map within a predetermined range are connected, and when a contour is in the region of the parallax map corresponding to the extracted connection region, generates a parallax histogram on the basis of the parallax of each pixel in the region of the parallax map corresponding to the extracted connection region.

10. The image processing apparatus according to claim 1,
wherein the color information of the pixel includes the brightness value of the pixel.

11. An image processing method comprising the steps of:
acquiring a plurality of images captured from two or more different viewpoints;
generating a parallax map in which a parallax represented by a difference between the pixel positions of corresponding pixels of a first image from among a plurality of acquired images and a second image captured from a viewpoint different from the first image corresponds with the pixel position of the first image;
from among the pixels of the first image corresponding to an attention pixel of the generated parallax map and peripheral pixels in the periphery of the attention pixel, extracting pixels having a difference in color information from color information of a pixel corresponding to the attention pixel of the parallax map within a predetermined range;
generating the parallax histogram on the basis of the parallax of each pixel of the parallax map corresponding to each extracted pixel; and
correcting the parallax of the attention pixel as a correction target on the basis of the generated parallax histogram.

12. The image processing method according to claim 11,
wherein, in the step of generating the histogram, a connection region is extracted which includes a pixel of the first image corresponding to the attention pixel of the generated parallax map and in which adjacent pixels having a difference in color information from color information of a pixel corresponding to the attention pixel of the parallax map within a predetermined range are connected.

13. An image processing program which causes a computer to function as:
an acquisition unit which acquires a plurality of images captured from two or more different viewpoints;
a parallax map generation unit for generating a parallax map in which a parallax represented by a difference between the pixel positions of corresponding pixels of a first image from among a plurality of images acquired by the acquisition unit and a second image captured from a viewpoint different from the first image corresponds with the pixel position of the first image;
a histogram generation unit which, from among the pixels of the first image corresponding to an attention pixel of the parallax map generated by the parallax map generation unit and peripheral pixels in the periphery of the attention pixel, extracts pixels having a difference in color information from color information of a pixel corresponding to the attention pixel of the parallax map within a predetermined range and generates a parallax histogram on the basis of the parallax of each pixel of the parallax map corresponding to each extracted pixel; and
a correction unit which corrects the parallax of the attention pixel as a correction target on the basis of the parallax histogram generated by the histogram generation unit.

14. The image processing program according to claim 13,
wherein the histogram generation unit extracts a connection region which includes a pixel of the first image corresponding to an attention pixel of the parallax map generated by the parallax map generation unit and in which adjacent pixels having a difference in color information from color information of a pixel corresponding to the attention pixel of the parallax map within a predetermined range are connected, and generates a parallax histogram on the basis of the parallax of each pixel in the region of the parallax map corresponding to the extracted connection region.

15. A multi-eye digital camera comprising:
the image processing apparatus according to claim 1; and
a display unit which displays an image in stereoscopic view on the basis of a parallax map generated and corrected by the image processing apparatus.
